(19) United States
(12) Patent Application Publication
(10) Pub. No.: US 2017/0372435 A1
(43) Pub. Date: Dec. 28, 2017

(54) METHODS AND SYSTEMS FOR PROCESSING RECORDS SUBMISSIONS FOR TAX ASSESSMENT

(71) Applicant: MASTERCARD INTERNATIONAL INCORPORATED, Purchase, NY (US)

(72) Inventor: Arunmurthy Gurunathan, Pune (IN)

(21) Appl. No.: 15/622,283

(22) Filed: Jun. 14, 2017

(30) Foreign Application Priority Data
Jun. 22, 2016 (SG) 10201605143Q

(51) Int. Cl. G06Q 40/00; G06F 17/30; G06Q 20/10

(52) U.S. Cl. CPC G06Q 40/123; G06Q 20/102; G06F 17/30312; G06F 17/30424

(57) ABSTRACT

A method of processing a record submission for tax assessment is disclosed. The method comprises receiving transaction data associated with an electronic payment transaction carried out using a payment account held by an account holder at a financial institution, said transaction data being indicative of a transaction amount. A tax account, which is held by the account holder at a tax authority, is identified through an association between the payment account and the tax account. Accordingly, the account holder may choose to associate the electronic payment transaction with the tax account such that the transaction data may be provided for tax assessment purposes. An apparatus for carrying out the method and associated methods and apparatus for obtaining and making records submissions for tax assessment are also disclosed.

### TECHNICAL FIELD AND BACKGROUND

The present invention relates to methods and apparatus for records submission for tax assessment, and in particular for making or processing submission of records in relation to electronic payment transactions.

Filing income tax return is a process in which individual tax payers declare their income and deductions (e.g. over non-taxable income) over an assessment period with the tax authority. This typically requires an individual's income and expense data within the entire assessment period to be submitted for tax assessment purposes. In certain countries, employers may submit employment income records for their employees at the tax authority. But for personal non-employment income as well as personal expenses which are relevant for tax assessment (such as insurance premium which may qualify tax deduction), the individual is required to declare them on their own initiative. In order to claim tax deduction from expense and donation, the individual needs to fill up forms and may be required to attach the proof of payment such as receipts for payment of certain medical bills for assessment and inspection. However, this process is tedious and may require handling of a large amount of data accumulated throughout the year, which also makes it prone to error and fraud.

Therefore, it is desirable to provide an improved method and system for making and processing records submissions for tax assessment.

### SUMMARY

In general terms, the present disclosure proposes obtaining and using an association between a payment account held by an account holder (e.g. a human subject) at financial institution and a tax account held by him at a tax authority such that electronic transactions carried out using the payment account may be automatically linked to the tax account for providing data records associated with tax-related transactions for tax assessment purposes, such as for assessing an amount of eligible income tax deduction for the account holder. For another example, such data records which are made available to the tax authority may automatically serve as a proof of payment in respect of the tax-related electronic transaction for supporting a claim made by the account holder at the tax authority.

According to a first aspect, there is provided a method of processing a records submission for tax assessment. The method comprises:
receiving transaction data associated with an electronic payment transaction carried out using a payment account held by an account holder at a financial institution, said transaction data being indicative of a transaction amount;
obtaining tax account data associated with the payment account, said tax account data being indicative of a tax account held by the account holder at a tax authority;
determining whether to submit the transaction data to the tax authority; and
if the determination is positive, transmitting the transaction data and the tax account data to the tax authority thereby causing the electronic payment transaction to be associated with the tax account by the tax authority.

This allows for a tax account, which is held by the individual at a tax authority, to be identified through an associated payment account. Accordingly, the account holder may choose to associate the electronic payment transaction carried out using the payment account with the tax account. This may allow the relevant transaction data to be automatically submitted to the tax authority for tax assessment purposes for the individual.

Typically, an individual's tax account may be identified by a tax account number which is unique and allows the individual (as the tax payer) to be identified uniquely within a context. For example, the tax account number may be the same as an identity card (IC) number or the social security number of the individual.

In some embodiments, the step of obtaining tax account data (e.g. the tax account number) comprises interrogating a database storing a pre-defined association between the tax account and the payment account.

In other embodiments, the step of obtaining tax account data comprises receiving data indicating the tax account specified by the account holder in respect of the electronic payment transaction.

In some embodiments, the step of transmitting the transaction data and the tax account data to the tax authority is carried out upon the electronic payment transaction having been cleared.

In some embodiments, the transaction data and the tax account data are transmitted to the tax authority by the financial institution at which the payment account was held, and the financial institution is the funding institution of the electronic payment transaction.

In some embodiments, the step of determining whether to submit the transaction data to the tax authority comprises receiving a selection by the account holder and making a determination in response to the selection. In one example, a query may be transmitted to the account holder and the selection is received in response to the query.

In some embodiments, the selection may be received via a communication device of the account holder.

In some embodiments, the electronic payment transaction is carried out using a payment card, such as credit card or debit card, held by a cardholder at an issuing bank.

In one embodiment, the issuing bank receives data representing the tax account via a merchant terminal associated with the electronic payment transaction.

In other embodiments, the electronic payment transaction is a person-to-person fund transfer.

In one embodiment, the transaction data comprises data representing the payment account. Additionally or alternatively, the transaction data comprises information indicating a purpose of the electronic payment transaction.

In some embodiments, further transaction data associated with a further electronic payment transaction carried out using the payment account is received. If it is determined to be submitted to the tax authority, the method may further comprise calculating an aggregated transaction amount for the electronic payment transaction and the further electronic payment transaction and transmitting the aggregated amount to the tax authority.

In some embodiments, the step of obtaining the tax account data is carried out prior to the electronic payment transaction having been cleared.

According to a second aspect, there is provided an apparatus for processing records submission for tax assessment. The apparatus has a processor and a data storage device storing program instructions being operative to cause the processor to carry out any one of the method described above.

In some embodiments, the processor is in communication with a database storing a pre-defined association between the tax account with the payment account. The processor is configured to obtain the tax account data using the database.

In some embodiments, the processor is configured to receive, via a client device, data indicating the tax account specified by the account holder in respect of the electronic payment transaction. In one example, the client device is a communication device of the account holder. In another example, the client device is a merchant's terminal associated with the electronic payment transaction.

In one example, the system is a server associated with a funding institution in respect of the electronic transaction.

In some embodiments, the processor is configured to receive a selection by the account holder and determine whether to submit the transaction data to the tax authority in response to the selection.

In some embodiments, the processor is configured to receive further transaction data to be submitted to the tax authority, the further transaction data being associated with a further electronic payment transaction carried out using the payment account, to calculate an aggregated transaction amount for the electronic payment transaction and the further electronic payment transaction, and to transmit the aggregated amount to the tax authority.

According to a third aspect, there is provided a method of obtaining records for tax assessment. The method comprises:
receiving transaction data associated with an electronic payment transaction carried out using a payment account held by an account holder at a financial institution, said transaction data being indicative of a transaction amount and the payment account;
identifying a tax account held by the account holder at a tax authority using the payment account; and
associating the electronic payment transaction with the tax account to facilitate tax assessment using the transaction data.

In some embodiments, the above method may be carried out by a server associated with the tax authority (also referred to as a tax server). In one embodiment, the method further comprises calculating a tax amount for the tax account using the transaction amount.

In another embodiment, the above method may be carried out by a records submission facilitator server which coordinates between a transaction records server and the tax server. For example, the facilitator server receives transaction records for submission from the transaction records server and tags the transactions to respective tax accounts for submission to the tax server. The processor may transmit the transaction data together with tax account data indicating the tax account to the tax server, for example, for calculation of a tax amount by the tax server.

In some embodiments, the step of identifying the tax account comprises interrogating a database storing a pre-defined association between the tax account with the payment account.

According to a further aspect, there is provided an apparatus for obtaining records for tax assessment. The apparatus comprises a processor and a data storage device storing program instructions being operative to cause the processor to:
receive transaction data associated with an electronic payment transaction carried out using a payment account held by an account holder at a financial institution, said transaction data being indicative of a transaction amount and the payment account;
identify a tax account held by the account holder at a tax authority using the payment account; and
associate the electronic payment transaction with the tax account to facilitate tax assessment using the transaction data.

In some embodiments, the processor is in communication with a database storing a pre-defined association between the tax account with the payment account and the processor is configured to identify the tax account using the database.

In some embodiments, the processor is configured to calculate a tax amount for the tax account using the transaction amount.

In another embodiment, the processor is in communication with a server of the tax authority (i.e. a tax server) for calculating a tax amount, and processor is configured to transmit the transaction data with tax account data indicating the associated tax account to the tax authority.

The present disclosure further proposes a server software product, such as at a time when it is stored in a non-transitory form on a tangible data storage device. The data storage device may be within the server, or it may be a database from which the server is able to download the software. In particular, there is proposed a server program product comprising computer program instructions which is operative, when implemented by a processor of a server, to cause the processor to perform any one of the methods described above.

According to yet a further aspect, there is provided a method of making a records submission for tax assessment. The method comprising a communication device, upon an electronic payment transaction being initiated using a payment account held by an account holder at a financial institution:
registering an input from the account holder;
determining, using the input, if the account holder authorizes a submission of transaction data associated with the electronic payment transaction to a tax authority, said transaction data being indicative of a transaction amount; and
if the determination is positive, causing the transaction data to be submitted to the tax authority.

In some embodiments, the method may further comprise associating the electronic payment transaction with a tax account held by the account holder at a tax authority. In one example, the data representing the tax account is received from the account holder via the communication device.

According to a yet a further aspect, there is provided a communication device. The communication device comprises a processor and a data storage device storing program instructions, the program instructions being operative, upon an electronic payment transaction being initiated using a payment account held by an account holder at a financial institution, to cause the processor:
to register an input from the account holder;
to determine, using the input, if the account holder authorizes a submission of transaction data associated with the electronic payment transaction to a tax authority, said transaction data being indicative of a transaction amount; and
if the determination is positive, to cause the transaction data to be submitted to the tax authority.

The present disclosure further proposes a software product, such as at a time when it is stored in a non-transitory form on a tangible data storage device. The data storage device may be within a communication device of a user, or it may be a database from which the communication device is able to download the software. In particular, there is proposed a program product comprising computer program instructions which is operative, when implemented by a processor of a communication device, to cause the processor to perform any one of the methods described above.

As used in this document, the term “funding institution” in relation to an electronic payment transaction refers to any financial institution which maintains a payment account which is used to provide funds for the transaction. For example, if the electronic payment transaction relates to a purchase made using a credit card, the card issuing bank is the funding institution. For another example, if the electronic payment transaction relates to a fund transfer from a payer to a payee, a bank at which the payer holds the payment account for funding the fund transfer is the funding institution.

As used in this document, the term “tax authority” includes any government entity that is authorized by law to assess, levy and collect taxes. The term “tax account” refers to an account maintained by the tax authority for the purpose of tax assessment and/or collection in relation to a taxable entity, which may be natural person or a legal person. The tax account may comprise any records associated with the taxable entity, which are relevant for tax assessment purposes. Depending on types of taxes, there may be different tax accounts to facilitate administration of the tax collection. Accordingly, the term “tax account” may be, but is not limited to, a personal income tax account. For example, the personal income tax account may comprise records of the individual's annual income data, tax-deductibles data such as medical-related expenses and provident fund contribution, and other tax-related data.

As used in this document, all steps of the method are preferably performed automatically.

The term “automatic” is used in this document to refer to a process which is performed substantially without human involvement, save possibly for initiation of the process.

As used in this document, the term “payment card” refers to any cashless payment device associated with a payment account, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers.

### BRIEF DESCRIPTION OF THE DRAWINGS

Embodiments of the disclosure will now be described for the sake of example only with reference to the following drawings, in which:

FIG. 1 shows a computerized network which is suitable to perform a method according to the present disclosure;

FIG. 2 is a flow diagram of an exemplary method according to one embodiment;

FIG. 3 is a flow diagram of an exemplary method according to another embodiment;

FIG. 4 is a flow diagram of an exemplary method according to a further embodiment;

FIG. 5 shows the technical architecture of a server of the computerized network of FIG. 1; and

FIG. 6 shows the technical architecture of a communication device of the computerized network of FIG. 1.

### DETAILED DESCRIPTION

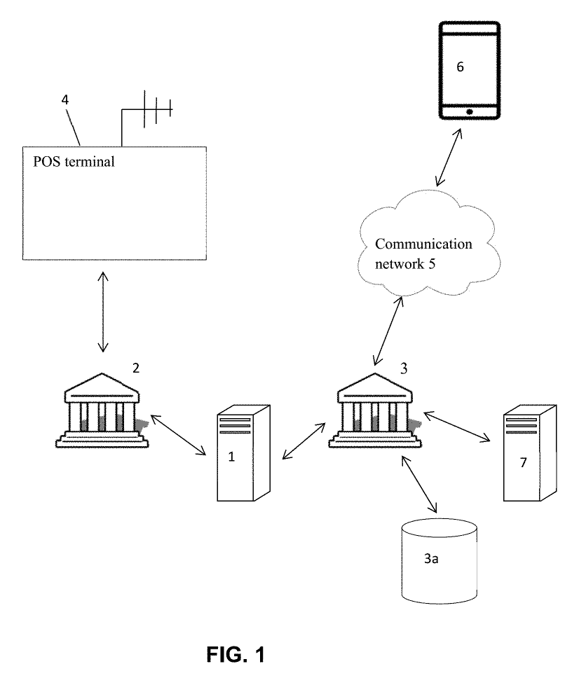

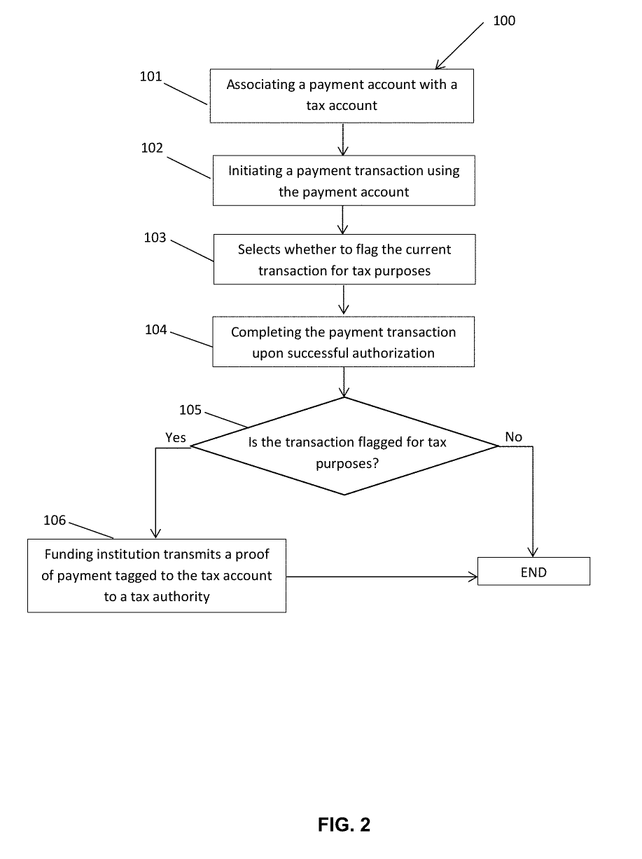

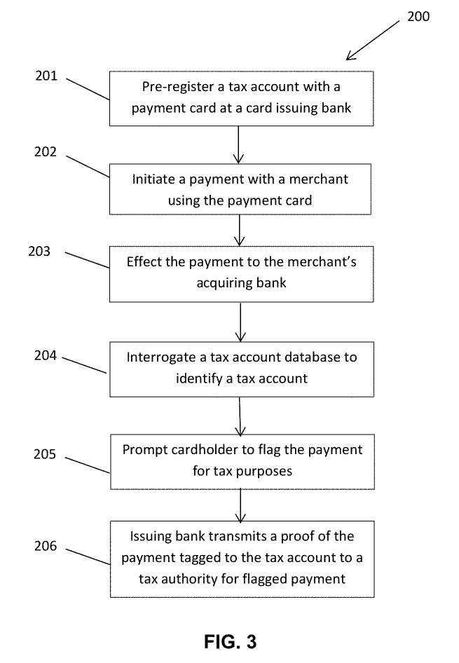

Referring to FIG. 1, a computerized network is shown which is suitable for performing methods of embodiments as illustrated by FIG. 2 and FIG. 3.

The computerized network comprises a payment network server 1 which facilitates an electronic payment transaction between a cardholder of a payment card such as a credit card or debit card, and a merchant. In particular, the payment network server 1 is in communication with an issuer system (e.g. an issuing bank server 3 operated by an issuing bank) and an acquirer system (e.g. an acquiring bank server 2 operated by an acquiring bank). As will be understood by a skilled person in the art, the payment network server 1 may be constituted by a payment processing organization such as MasterCard, having suitable processing apparatus.

Typically, a purchasing transaction starts with the cardholder presenting the payment card to a merchant which has a POS (point-of-sales) terminal 4 operable to read the details of the payment card, and prepare a transaction request including data indicative of the amount of the purchase to the acquiring bank server 2 at which the merchant maintains an account. The acquirer bank server 2 contacts the payment network server 1 of the payment network, and passes on the data encoding payment card details and the amount of the purchase. The payment network server 1 uses the payment card details to identify the issuer bank. The payment network server 1 contacts the issuer bank server 3, and sends it the payment card details and the amount of the purchase. The issuer bank server 3 decides either to authorize the purchase, or not to, and sends a corresponding message to the payment network server 1. If the issuer bank server 3 authorized the transaction, then the purchase is now completed. At some later time (during clearing and settlement operations), the issuer bank transfers the payment amount to the acquirer bank.

In this embodiment, the issuing bank server 3 further comprises or is communicatively coupled with an account database 3a storing a pre-defined association between a payment account held by the account holder at the issuing bank and a tax account held by the account holder at a tax authority. Note that a tax account may be associated with one or more payment accounts, as a user may hold more than one payment accounts or payment cards at one bank. The issuing bank server 3 is configured to interrogate the account database 3a to obtain the associated tax account data (e.g. a tax account number) for a given payment account.

In this example, the issuing bank server 3 is also in communication with a communication device, such as a mobile phone 6, of the account holder via a communication network 5. The issuing bank server 3 may receive data indicating the tax account specified by the account holder via the mobile phone 6. It will be understood that in another embodiment, the communication device may be a smart watch, a tablet computer, or the like, which allows for data input from a user and allows for transmission to and from the issuing bank server 3.

The issuing bank server 3 is further communicatively coupled to a server 7 of the tax authority (i.e. the tax server 7), for example, the issuing bank server 3 may be configured to transmit the transaction data and the tax account data to the tax authority.

As will be understood by a skilled person, each of the various devices in the computerized network 1 has a communication module such as wireless interface for two-way communication between one and another via a communication network. The communication network could be any types of network, for example, virtual private network (VPN), the Internet, a local area and/or wide area network (LAN and/or WAN), and so on.

Exemplary methods of the present disclosure will now be illustrated with reference to FIGS. 2-4 in which the operations are enumerated. It should also be noted that enumeration of operations is for purposes of clarity and that the operations need not be performed in the order implied by the enumeration.

Referring to FIG. 1, at step 101, an association is created between a payment account and a tax account of an individual. This may be done by the account holder registering his or her payment account or accounts and the tax account number through a registration process. For example, the registration may be carried out by submitting the information to an account database management system, which may be operated by the issuing bank or the tax authority. An account database 3a which stores a pre-defined mapping between the payment account and the tax account is formed. The database may be maintained by a tax authority or a financial institution such as the bank.

At step 102, an electronic payment transaction is initiated using the payment account. For example, a consumer may make a purchase using a credit card at a merchant. The consumer may select whether to flag the current transaction for tax purposes such that the transaction data relating to the current transaction will be transmitted to a tax authority for assessment at step 103. The payment transaction may subsequently be processed in a known manner whereby the merchant sends a transaction request to the payment network 1 via a payment gateway. The acquiring bank 2 then processes the request and transmits it to the card issuing bank 3 for authorization at step 104. The payment is cleared and settled, and funds are transferred to the acquirer system for storing in the merchant account. Non-limiting examples of the payment network are a payment card type of network such as the payment processing network operative by MasterCard, Inc.

At step 105, the system makes a determination as to whether or not to transmit data relating to the transaction to the tax authority. Typically, the determination is made in response to the consumer's selection at step 103.

If the determination is positive, the transaction data is tagged to the associated tax account number and is transmitted to the tax authority at step 106. In this example, the funding institution, i.e. the issuing bank, electronically transmits the transaction data to the tax authority. If the consumer chooses not to flag the current transaction for tax purposes, the transaction data is simply stored by the payment network 1 and/or the issuing bank server 3, and not shared with the tax authority.

Turning to FIG. 3, which illustrates a flow of another exemplary method 200 of the present disclosure. The method 200 is described with respect to an electronic payment transaction relating to a purchase made at a merchant's premise using a credit card. According to a particular example, the purchase may be made for a treatment (e.g. a medicine or for performing a medical procedure) at a hospital, which may be eligible for tax deduction.

At step 201, a one-time registration step is carried out at the card issuing bank. This may be carried out in a way similar to step 101 described above. In particular, the card holder may register provide the credit card number and the tax account number for the registration. According to a particular example, the registration step may be carried out during an application process for a credit card by the card holder. In that case, the tax account number is provided to the card issuing bank during the application process, and is automatically associated with the credit card number that will assigned to the card.

When the consumer makes a purchase using a credit card at step 202, the credit card data is read by a merchant terminal, such as the POS terminal 4 which prepares and submits a transaction request for the purchase for processing by the payment network.

At step 203, the card issuing bank receiving the transaction request and authorizes the transaction. The transaction request typically comprises data indicative of a merchant ID, a transaction amount, and/or a transaction time, etc. The transaction request may further comprise data indicative of the payment account details and/or a purpose of the electronic payment transaction. Upon transaction clearing and settlement operations being carried out, funds for the transaction amount are transferred to the acquiring bank.

At step 204, the card issuing bank obtains the tax account number associated with the payment account. For example, the card issuing bank determines if a tax account corresponding to the payment account can be found in the account database. In other words, the card issuing bank may interrogate the database to determine if an entry defining an association between the payment account and a tax account exists and if so retrieving data representing the tax account from the database. In a variant, the tax account number may be obtained from the merchant's terminal 4 which includes the tax account number as a part of the transaction request. In particular, the step of obtaining the tax account number may be carried out prior to the electronic payment transaction having been cleared.

The card issuing bank server 3 may determine whether to submit the transaction data to the tax authority in response to a selection by the account holder. In this embodiment, at step 205, the cardholder may be prompted to confirm if a given electronic transaction is to be flagged for tax purposes and to be transmitted to the tax authority.

For example, the server 3 may send a query message to a registered mobile phone of the cardholder as to whether or not to submit the transaction data to the tax authority. A response may be received from the cardholder via the mobile phone 6 which registers the cardholder's selection. In some embodiments, the query message may prompt the cardholder to input a tax account number with which the transaction is to be associated. This may happen if the server fails to identify an associated tax account for the payment account. Alternatively, the cardholder may opt to associate with the transaction with a new tax account, rather than the default tax account which is retrieved from the account database based on an existing entry in the account database 3a. The cardholder may input the new tax account number via the mobile phone 6 which then transmits the tax account number to the issuing bank. The new tax account may be subsequently stored by the account database to form a new entry, or to replace the existing entry.

In response to the selection, the card issuing bank transmits the transaction data and the tax account number to the tax authority at step 206 which allows the tax authority to identify the electronic payment transaction as relating to the particular tax account. As will be understood, the selection may be registered by the user making an active input via an input terminal, for example, by registering a user's tapping action on a touch-screen or a voice command via a microphone of the communication device 6. In some embodiments, an active input from the user may not be required. For example, in the absence of the user's action, the default tax account (e.g. which is associated with the payment account in the account database) may be registered as the user's selection. For another example, if no input is received from the user, a default selection may be set and registered as a selection not to transmit the transaction data to the tax authority. For another example, receiving a tax account number entered by the cardholder at step 205 may be registered as an affirmative selection to transmit the transaction data to the tax authority. In a variation, the selection or the tax account number may be received via the merchant terminal 4.

The transaction data and the tax account number may be encoded in one data package for transmission. The data package may be encrypted before transmission for security purposes.

In this embodiment, the server 3 transmits the transaction data and the tax account number to the tax authority. In a variant, the transmission may be carried out by another party, such as by the payment network server 1.

In addition, the submission may be made instantly and in real time as the electronic payment transaction is processed by a payment network. In some embodiments, the step of transmitting the transaction data to the tax authority is carried out upon the electronic payment transaction having been cleared.

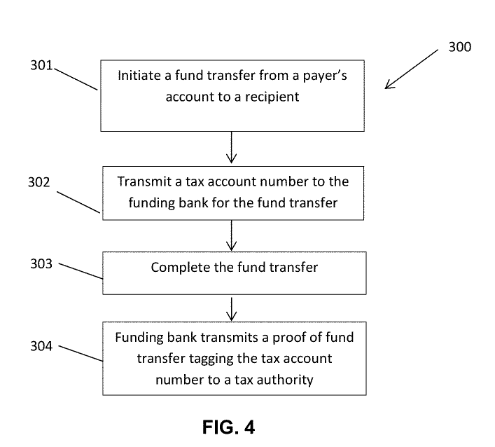

FIG. 4 illustrates a flow of another exemplary method 300 according to the present disclosure. The method 300 will be illustrated with respect to an electronic payment transaction which is a person-to-person fund transfer, such as for the purpose of paying a house rent.

At step 301, a fund transfer request is initiate by a payer to a payee, for example, through a ATM machine or via an online banking website of the funding institution, i.e. the payer's bank.

At step 302, data encoding the tax account number may be transferred to the payer's bank with the other details pertaining to the fund transfer. In a particular example, the fund transfer request may allow the account holder to specify the tax account together with other details of the fund transfer such as the transaction amount and a recipient account. In a variant, the payer's bank may access the account database to identify the tax account associated with the payer's account.

Upon completion of the fund transfer at step 303, the payer's bank transmits the fund transfer data together with the tax account data to the tax authority. Typically, the fund transfer data includes information describing a transaction amount, a payer's account, and/or a payee's account.

Typically, further transaction data associated with a further electronic payment transaction carried out using the payment account may be received. An aggregated transaction amount may be calculated for the plurality of electronic payment transactions which are linked to the same payment account, and the aggregated amount is transmitted to the tax authority. In a variant, the aggregated amount is calculated by the tax server 7. Optionally, the tax server 7 is configured to transmit the outcome of tax assessment to the employer of the individual for collection of tax. For example, in some countries, an income tax may be deducted directly from the employee's wage by the employer for submission to the tax authority.

In addition, the embodiments described above may comprise a step of presenting the transaction data or aggregated transaction data for the account holder's review and confirmation before transmission to the tax authority. For example, the transaction data transmitted by the server 3 may be stored in a designated database tentatively, and the data are transmitted to the tax authority upon the account holder's final confirmation.

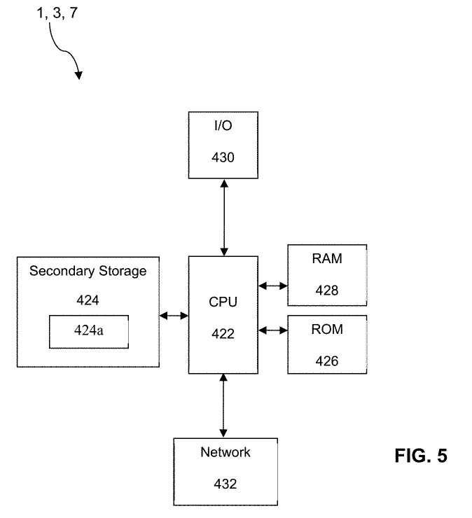

FIG. 5 is a block diagram showing a technical architecture of a server computer (e.g. the payment network server 1, the issuing bank server 3 or the tax server 7) suitable for implementing the present method.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

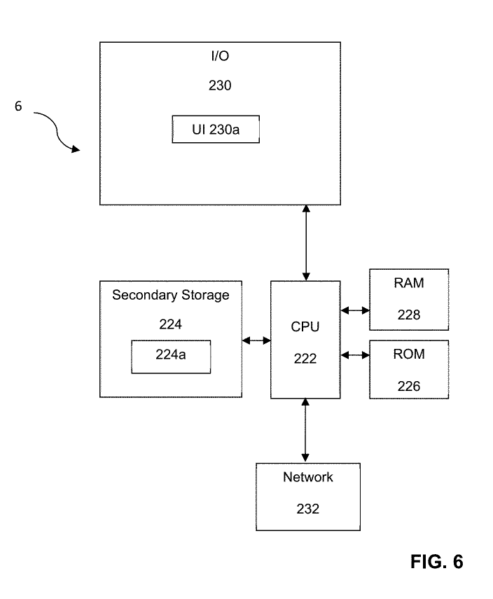

FIG. 6 is a block diagram showing a technical architecture of a communication device (e.g. the payer's mobile phone 6). The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further comprises input/output (I/O) devices 230, and network connectivity devices 232.

The I/O devices comprise a consumer interface (UI) 230. The UI 230a may comprise a screen in the form of a touch screen, a keyboard, a keypad or other known input device.

The secondary storage 224 is typically comprised of a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure. For example, the account database may be administered by another party other than the banks or the tax authority, which collects account holder's data and maintains the database. The account database may store payment account data associated with a plurality of payment accounts held by the account holder at one bank or across different banks. The party may grant controlled access to the account database to the tax authority or the banks upon appropriate authorization and/or authentication. It will be understood that the present method may also be applied to purchases made by a consumer via the internet such as through an online merchant's website or platform, and are not limited to those made at the merchant's retail premise.

1. A method of processing a records submission for tax assessment, the method comprising:
receiving transaction data associated with an electronic payment transaction carried out using a payment account held by an account holder at a financial institution, said transaction data being indicative of a transaction amount;
obtaining tax account data associated with the payment account, said tax account data being indicative of a tax account held by the account holder at a tax authority;
determining whether to submit the transaction data to the tax authority; and
if the determination is positive, transmitting the transaction data and the tax account data to the tax authority thereby causing the electronic payment transaction to be associated with the tax account by the tax authority.

2. The method according to claim 1, wherein obtaining tax account data comprises interrogating a database storing a pre-defined association between the tax account and the payment account.

3. The method according to claim 1, wherein obtaining tax account data comprises receiving data indicating the tax account specified by the account holder in respect of the electronic payment transaction.

4. The method according to claim 1, wherein transmitting the transaction data and the tax account data to the tax authority is carried out upon the electronic payment transaction having been cleared.

5. The method according to claim 1, wherein determining whether to submit the transaction data to the tax authority comprises receiving a selection by the account holder and making a determination in response to the selection.

6. The method according to claim 5 further comprising transmitting a query to the account holder and receiving the selection in response to the query.

7. The method according to claim 5 further comprising receiving the selection via a communication device of the account holder.

8. The method according to claim 1, wherein the electronic payment transaction is carried out using a payment card held by a cardholder at an issuing bank.

9. The method according to claim 8 further comprising the issuing bank receiving data representing the tax account via a merchant terminal associated with the electronic payment transaction.

10. The method according to claim 1, wherein the transaction data comprises data representing the payment account.

11. The method according to claim 1, wherein the transaction data comprises information indicating a purpose of the electronic payment transaction.

12. The method according to claim 1 further comprising obtaining the tax account data prior to the electronic payment transaction having been cleared.

13. An apparatus for processing records submission for tax assessment, the apparatus comprising a processor and a data storage device storing program instructions:
the program instructions being operative to cause the processor to:
receive transaction data associated with an electronic payment transaction carried out using a payment account held by an account holder at a financial institution, said transaction data being indicative of a transaction amount;
obtain tax account data associated with the payment account, said tax account data being indicative of a tax account held by the account holder at a tax authority;
determine whether to submit the transaction data to the tax authority; and
if the determination is positive, transmit the transaction data and the tax account data to the tax authority thereby causing the electronic payment transaction to be associated with the tax account by the tax authority.

14. The apparatus according to claim 13, wherein the processor is in communication with a database storing a pre-defined association between the tax account with the payment account, wherein the instructions are operative to cause the processor to obtain the tax account data using the database.

15. The apparatus according to claim 13, wherein the instructions are operative to cause the processor to receive, via a client device, data indicating the tax account specified by the account holder in respect of the electronic payment transaction.

16. The apparatus according to claim 15, wherein the client device is a communication device of the account holder.

17. The apparatus according to claim 15, wherein the client device is a merchant's terminal associated with the electronic payment transaction.

18. The apparatus according to claim 13, wherein the instructions are operative to cause the processor to transmit the transaction data and the tax account data to the tax authority is carried out upon the electronic payment transaction having been cleared.

19. An apparatus for obtaining records for tax assessment, the apparatus comprising a processor and a data storage device storing program instructions:
the program instructions being operative to cause the processor to:
receive transaction data associated with an electronic payment transaction carried out using a payment account held by an account holder at a financial institution, said transaction data being indicative of a transaction amount and the payment account;
identify a tax account held by the account holder at a tax authority using the payment account; and
associate the electronic payment transaction with the tax account to facilitate tax assessment using the transaction data.

20. The apparatus according to claim 19, wherein the instructions are operative to cause the processor to calculate a tax amount for the tax account using the transaction amount.

21. The apparatus according to claim 19, wherein the processor is in communication with a server of the tax authority, wherein the instructions are operative to cause the processor to transmit the transaction data with tax account data indicating the associated tax account to the server of the tax authority.

22. The apparatus according to claim 19, wherein the processor is in communication with a database storing a pre-defined association between the tax account with the payment account, wherein the instructions are operative to cause the processor to identify the tax account using the database.
